(19) United States
(12) Patent Application Publication
(10) Pub. No.: US 2021/0094418 A1
(43) Pub. Date: Apr. 1, 2021

(54) DISPLAY DEVICE FOR VEHICLE

(71) Applicant: SOLID YEAR CO., LTD., New Taipei City (TW)

(72) Inventors: HUI-PING LIANG, Xiushui Township (TW); TSANG-LIN LIANG, Xiushui Township (TW)

(21) Appl. No.: 16/893,627

(22) Filed: Jun. 5, 2020

(30) Foreign Application Priority Data
Sep. 30, 2019 (TW) 108212944

(51) Int. Cl. B60K 35/00; H04N 9/31; G06T 7/50; G08G 1/16; B60Q 9/00; B60R 11/00

(52) U.S. Cl. CPC B60K 35/00; H04N 9/31; G06T 7/50; G08G 1/167; B60Q 9/008; B60K 2370/179; G06T 2207/10016; G06T 2207/10044; G06T 2207/30261; G06T 2207/30236; B60K 2370/152; B60R 11/00

(57) ABSTRACT

A display device, includes an image projection module mounted in a vehicle for projecting a driving assistance image toward the front windshield of the vehicle corresponding to the driving of the vehicle, a sensor module mounted in the vehicle for detecting the status of people and vehicles in the vicinity of the vehicle, and a control module electrically connected with the sensor module and the image projection module for displaying warning signals through the image projection module corresponding to the status of people and vehicles near the vehicle detected by the sensor module. The present invention uses the above technical features to allow the driver to obtain all driving information in a more integrated and intuitive way, improving the convenience of use and vehicle driving safety.

### BACKGROUND OF THE INVENTION

### 1. Field of the Invention

The present invention relates to vehicle technology and more particularly, to a display device for vehicles.

### 2. Description of the Related Art

With the rapid development of automotive technology, in addition to the continuous improvement of automotive power performance, various vehicle safety systems have also been continuously used to help drivers reduce traffic accidents and improve the safety of all road users.

The current vehicle safety systems are mainly divided into active safety protection and passive safety protection. Although the aforementioned active or passive safety protection can respectively achieve different safety auxiliary functions, various functions are still displayed or warned in different ways in a decentralized manner, so that drivers must cooperate with various warning methods to obtain the desired information. The use method is less intuitive and complicated, and it can no longer improve driving safety.

### SUMMARY OF THE INVENTION

The present invention has been accomplished under the circumstances in view. It is the main object of the present invention to provide a display device for vehicles, which allows drivers to obtain all driving information in a more integrated and intuitive way, improving convenience of use and driving safety of vehicles.

To achieve this and other objects of the present invention, a display device for vehicles comprises an image projection module, a sensor module and a control module. The image projection module is mounted in the vehicle and adapted to project a driving assistance image toward the front windshield of the vehicle corresponding to the driving of the vehicle. The sensor module is mounted in the vehicle and adapted to detect the status of people and vehicles in the vicinity of the vehicle. The control module is electrically connected with the sensor module and the image projection module and adapted to display warning signals through the image projection module corresponding to the status of people and vehicles near the vehicle detected by the sensor module. The present invention uses the above technical features to allow the driver to obtain all driving information in a more integrated and intuitive way, improving the convenience of use and vehicle driving safety.

Preferably, the image projection module comprises a display unit and a refraction unit. The refraction unit is set on the top side of the front dashboard of the vehicle. The display unit is disposed adjacent to the refraction unit and used to project a driving assistance image toward the refraction unit. The refraction unit is used to project the driving assistance image toward the front windshield of the vehicle.

Preferably, the sensor module optionally comprises a video camera unit, a radar unit, or an inertial measurement unit.

Preferably, the control module drives the image projection module to display steering information or warning signals in direction toward the front windshield of the vehicle according to the steering of the vehicle detected by the sensor module,

Preferably, the sensor module senses the distance between the vehicle and the other vehicle in front, and then displays the vehicle distance line or the vehicle distance warning reminder through the image projection module.

Preferably, when the sensor module senses another vehicle in the side or rear blind spot of the vehicle, the control module calculates and determines whether the distance is a safe value, a warning value, or a dangerous value according to the distance between the vehicle and the said another vehicles detected by the sensor module, in turn, the image projection module displays safety, warning, or danger through different warning signals.

Preferably, the display device further comprises a time delay device electrically connected to the image projection module, the sensor module and the control module. After the vehicle is stopped and powered off, the time delay device supplies power to the control module, the sensor module and the image projection module for a predetermined period of time before stopping.

The detailed structure or features provided by the present invention will be described in the subsequent detailed description of the preferred embodiment. However, those skilled in the art should be able to understand that this detailed description and the specific embodiment embodying the present invention are only used to illustrate the invention, not to limit the scope of protection of the claims of the invention.

### BRIEF DESCRIPTION OF THE DRAWINGS

FIG. 1 is a schematic diagram of a preferred embodiment of the present invention, mainly showing the composition structure of the display device.

FIG. 2 is a schematic diagram of the application of the preferred embodiment of the present invention, mainly showing a driving assistance image.

FIG. 3 is a schematic diagram of the application of the preferred embodiment of the present invention, mainly showing another driving assistance image.

FIG. 4 is a schematic diagram of the application of the preferred embodiment of the present invention, mainly showing still another driving assistance image.

FIG. 5 is a schematic diagram of the application of the preferred embodiment of the present invention, mainly showing the state of auxiliary detection of the blind spot.

FIG. 6 is a schematic diagram of the application of the preferred embodiment of the present invention, mainly showing the state of the auxiliary warning of reverse parking.

### DETAILED DESCRIPTION OF THE INVENTION

The technical content and features of the present invention are described in detail below by listing preferred embodiments and drawings. The display device for vehicle provided by the present invention can be widely used in various vehicles. Those skilled in the art can understand that the description language of this embodiment belongs to a general description that does not limit the application field. For example, the terms of materials or shapes include and are not limited to the materials or shapes specified in the description, and the terms of location include and are not limited to setting, approaching, connecting, or abutting. The number of elements “one” includes one and more than one number of elements. The directional adjectives such as “upper”, “lower”, “inner”, “outer”, “top”, and “bottom mentioned in the content of this specification are only examples of description terms based on the normal direction of use, not intended to limit the scope of the claims.

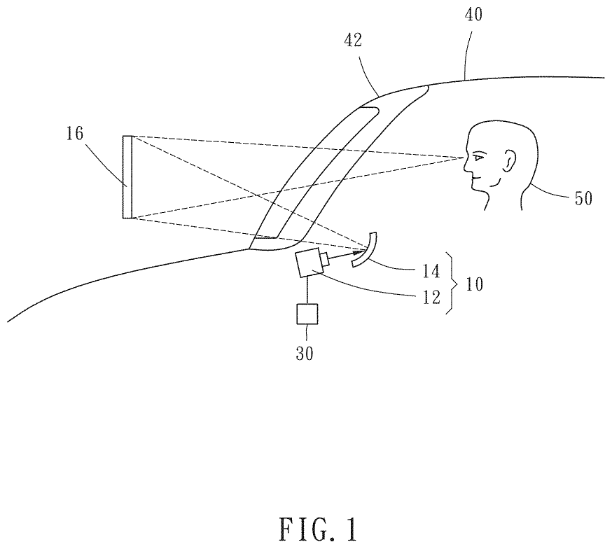

Referring to FIG. 1, a display device for vehicles in accordance with the present invention comprises an image projection module 10, a sensor module 20 and a control module 30. The image projection module 10 comprises a display unit 12 and a refraction unit 14. The refraction unit 14 is set on the top side of the front dashboard of the vehicle 40. The display unit 12 is disposed adjacent to the refraction unit 14 and can project a driving assistance image 16 toward the refraction unit 14. The refraction unit 14 projects the driving assistance image 16 toward the front windshield 42 of the vehicle 40. The driving assistance image 16 can be displayed in a reflective area on the surface of the front windshield 42, or virtually imaged on the outside of the front windshield 42, so that the driver 50 can simultaneously see the various driving information required to drive the vehicle 40 from the front.

The sensor module 20 is mounted in the vehicle 40. The sensor module 20 in the present preferred embodiment can optionally comprise a video camera unit, a radar unit, or an inertial measurement unit. The sensor module 20 can detect the status of people and vehicles in the vicinity of the vehicle 40. Optionally, the invention further comprises a time delay device electrically connected to the image projection module 10, the sensor module 20 and the control module 30. After the vehicle 40 is stopped and powered off, the time delay device can still supply power to the control module 30, the sensor module 20 and the image projection module 10 for a predetermined period of time before stopping.

The control module 30 is electrically connected to the sensor module 20 and the image projection module 10. The control module 30 generates warning signals corresponding to the distance or status of people and vehicles near the vehicle 40 detected by the sensor module 20 and displays the generated warning signals through the image projection module 10, so that the driver 50 can directly see various warning signals.

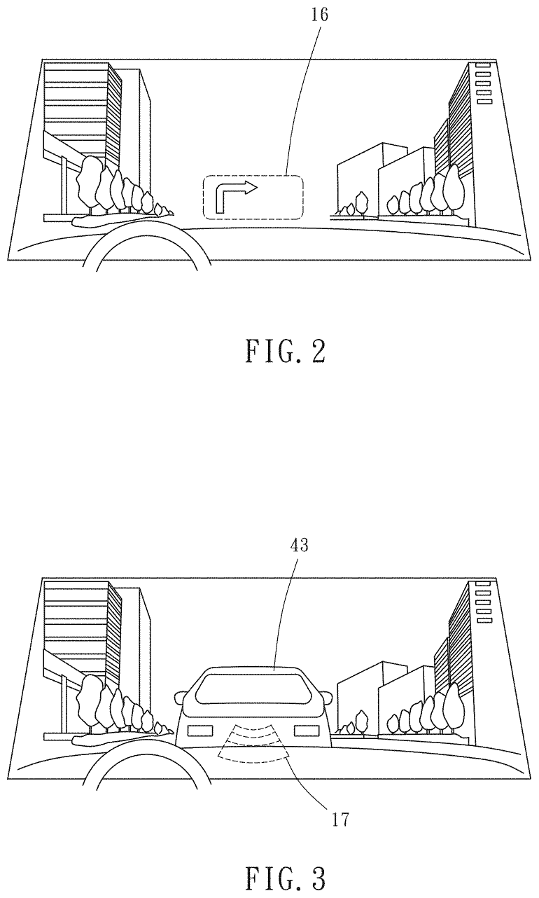

Based on the aforementioned composition requirements, the present invention uses the sensor module 20 and the control module 30 to determine the status of the people and vehicles near the vehicle 40, and allows the image projection module 10 to display the auxiliary driving and warning functions of driving direction indication, navigation, driving distance, blind spot detection, and rear parking prediction. As shown in FIG. 2, when the vehicle 40 is about to turn, the control module 30 can recognize the steering of the vehicle 40 according to the rotation mode of the left and right levers and steering wheel of the driver's operation detected by the sensor module 20, and then let the image projection module 10 show the steering information in the direction of the front windshield 42. The sensor module 20 can also help confirm whether there are any items or people in front of the vehicle 40 blocked by the A pillar of the vehicle 40, reminding the driver in advance and stopping the vehicle.

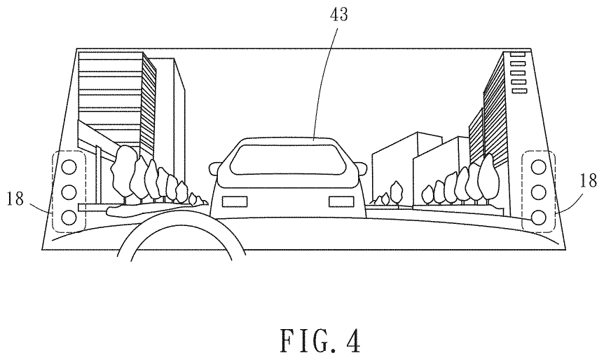

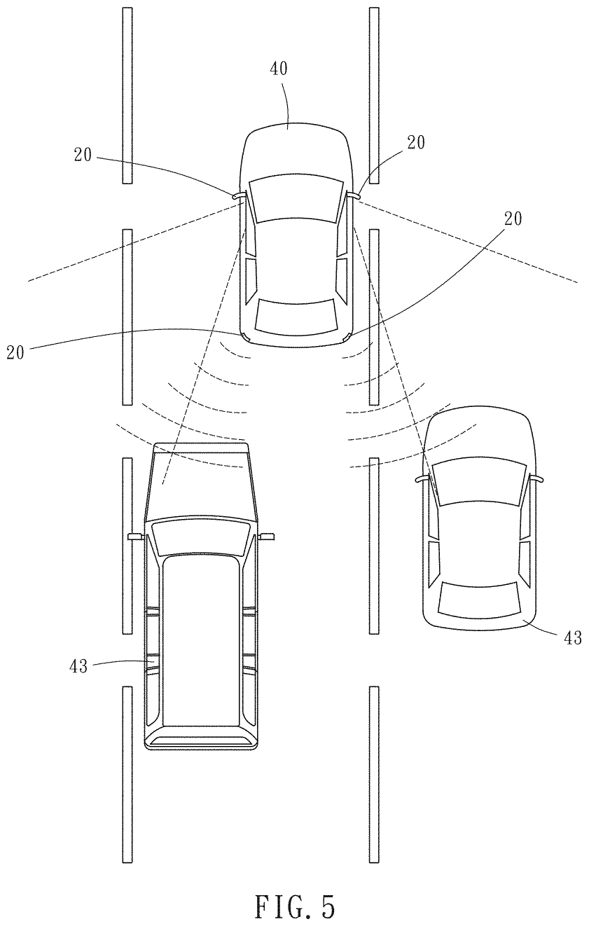

As shown in FIG. 3, the sensor module 20 can also sense the distance between the vehicle 40 and the other vehicle 43 in front, and then display the vehicle distance line 17 or the vehicle distance warning reminder through the image projection module 10. As shown in FIG. 4 and FIG. 5, when the sensor module 20 senses that there are other vehicles 43 in the side and rear blind spots of the vehicle 40, according to the distance between the vehicle 40 and other vehicles 43 detected by the sensor module 20, the control module 30 calculates and determines whether the distance is a safe value, a warning value, or a dangerous value, in turn, the image projection module 10 displays safety, warning, or danger through different warning signals 18. In addition, the control module 30 can also determine whether there is a dangerous vehicle nearby when changing lanes and use the image projection module 10 to display the dangerous signal synchronously.

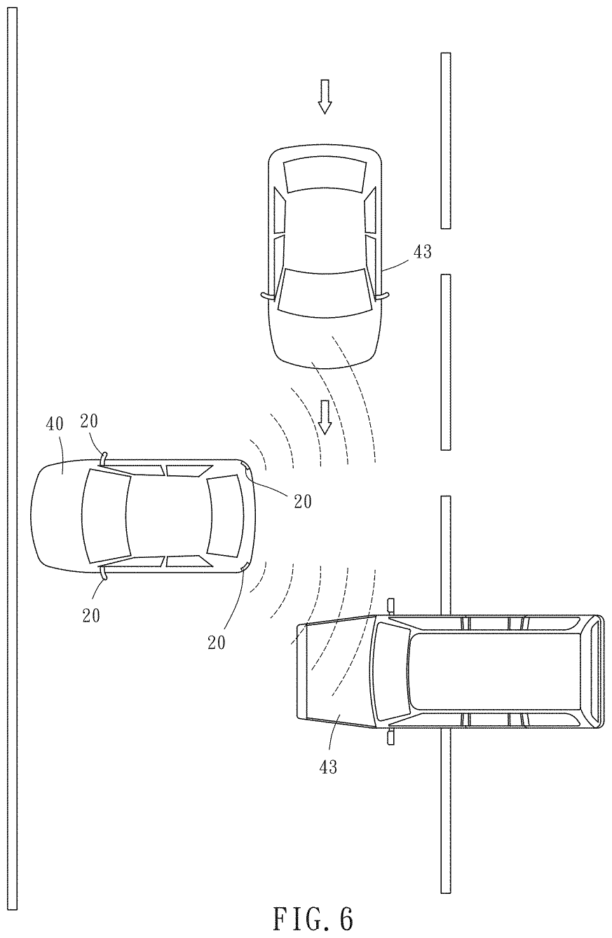

As shown in FIG. 6, the sensor module 20 can detect the surroundings behind the vehicle 40 when the vehicle is reversing. If there are other vehicles 43 behind the vehicle 40, the control module 30 can also synchronize the image projection module 10 with the information obtained by the sensor module 20 and display it to the driver, and can judge and display whether the status of the other vehicle 43 behind is sufficient for the driver to move the vehicle 40 back to the lane. It is worth mentioning that when the sensor module 20 is installed in the doors of the vehicle 40, the control module 30 can also be used as a warning judgment for the door opening, so that the driver can know the full safety auxiliary information from the image projection module 10 without turning the head. The present invention uses the aforementioned technical features to achieve the purpose of allowing the driver to obtain the driving information in a more intuitive way, improving the convenience of use and vehicle driving safety.

What is claimed is:

1. A display device used in a vehicle, comprising:
an image projection module mounted in said vehicle and adapted to project a driving assistance image toward a front windshield of said vehicle corresponding to the driving of said vehicle;
a sensor module mounted in said vehicle and adapted to detect the status of people and vehicles in the vicinity of said vehicle; and
a control module electrically connected with said sensor module and said image projection module and adapted to display warning signals through said image projection module corresponding to the status of people and vehicles near said vehicle detected by said sensor module.

2. The display device as claimed in claim 1, wherein said image projection module comprises a display unit and a refraction unit, said refraction unit being set on a top side of a front dashboard of said vehicle, said display unit being disposed adjacent to said refraction unit and used to project a driving assistance image toward said refraction unit, said refraction unit being used to project said driving assistance image toward said front windshield of said vehicle.

3. The display device as claimed in claim 1, wherein said sensor module optionally comprises a video camera unit, a radar unit, or an inertial measurement unit.

4. The display device as claimed in claim 1, wherein said control module drives said image projection module to display steering information or warning signals in direction toward said front windshield of said vehicle according to the steering of said vehicle detected by said sensor module,

5. The display device as claimed in claim 1, wherein said sensor module senses the distance between said vehicle and the other vehicle in front, and then displays the vehicle distance line or the vehicle distance warning reminder through said image projection module.

6. The display device as claimed in claim 1, wherein when said sensor module senses another vehicle in the side or rear blind spot of said vehicle, said control module calculates and determines whether the distance is a safe value, a warning value, or a dangerous value according to the distance between said vehicle and said another vehicles detected by said sensor module, in turn, said image projection module displays safety, warning, or danger through different warning signals.

7. The display device as claimed in claim 1, further comprising a time delay device electrically connected to said image projection module, said sensor module and said control module, said time delay device supplying power to said control module, said sensor module and said image projection module for a predetermined period of time after said vehicle is stopped and powered off.
